(19) United States
(12) Patent Application Publication
(10) Pub. No.: US 2004/0263322 A1
(43) Pub. Date: Dec. 30, 2004

(54) Annunciator

(76) Inventors: Naoko Onaru, Osaka (JP); Mika Mizutani, Hyogo (JP); Masaharu Matsuoka, Osaka (JP); Nirou Komura, Osaka (JP); Kazuko Nishida, Kyoto (JP); Yoshio Tsuchida, Ishikawa (JP); Akinori Komatsubara, Ishikawa (JP)

Correspondence Address: Allan Ratner, RatnerPrestia, One Westlakes Berwyn Suite 301, PO Box 980, Valley Forge, PA, 19482-0980, US

(21) Appl. No.: 10/482,082

(22) PCT Filed: Apr. 1, 2003
(86) PCT No.: PCT/JP03/04152

(30) Foreign Application Priority Data
Apr. 1, 2002 (JP) 2002-98378
Aug. 11, 2002 (JP) 2002-32193

(51) Int. Cl. G08B 3/10

(52) U.S. Cl. 340/384.7

(57) ABSTRACT

The present invention provides an alerting tone that daily life noises cannot mask, and that is therefore optimum to both young and elderly people. Through specifying various household activities performed in a home, measuring and analyzing frequency of the relevant operating noises (daily life noises) and quantitatively defining the actual status of background noises in a home where electric appliances are being used, alerting devices output an alerting tone having a predominant frequency substantially in a range lower than 3 kHz but not lower than 1.5 kHz, as an alerting tone designed in consideration of the daily life noises, and having the optimum frequency and sounding pattern for various apparatus.

### TECHNICAL FIELD

The present invention relates to an alerting device to be used in an apparatus for assuring completion of a switching operation or notifying an operational status of an electric appliance or the like for home, commercial or industrial use.

### BACKGROUND ART

Along with the increase of functions and the progress in automation in home electric appliances, more and more products are introducing an alerting tone for announcing a status of the product, assuring completion of an operation or urging a user to proceed to the next step of an operation.

For example, a rice cooker, an electric jar pot or a washing machine emits a so-called “peep tone” to alert a user that cooking or washing has been completed, or that a trouble has occurred with the product. It is no longer exceptional that a single product emits different tones according to the purpose.

Accordingly, auditory information such as an alerting tone from a product is no less important than visual information, therefore it is desirous to employ an appropriate alerting tone for the purpose of upgrading the operability of the product.

Also, in accordance with the increase of cases where a senior aged person living alone has to operate a product by him/herself, resultant from the aging of population, it is essential that the alerting tone is sufficiently audible and that its message is easily identifiable, from the viewpoint of universal design.

Approaches disclosed in the JP-A No. 4-338420 and JP-A No. 9-101796 can be cited as examples of studies pursued up to now on the alerting tone. The entire disclosure of the JP-A No. 4-338420 and JP-A No. 9-101796 is incorporated herein by reference in their entirety.

However, these literatures have not yet established a designing orientation meticulously conceived based on a statistic data obtained through actual measurement and analysis of background noises observed in the actual daily life, based on actual situation in which a user uses an electric appliance in his/her actual living scene and types of daily life noises generated therein.

Specifically, although these days a growing number of products are designed to output an alerting tone of a lower frequency in compliance with the aging of the society, the idea of lowering the frequency has been simply established depending solely on data showing decline of auditory capacity characteristics of elderly people without taking the daily life noises in their living space into consideration. Therefore such design is even prone to cause a reverse effect that the alerting tone is mixed in the daily life noises and becomes inaudible.

In other words, despite the fact that in a home various noises are being caused by daily household activities such as cooking and cleaning and the alerting tone of an electric appliance is often drowned out by those noises (masked by those noises), the alerting tone is not designed in consideration of such daily life noises.

Up until now neither data by which a frequency of an alerting tone that is equally audible to elderly people and younger people can be determined, nor data that can endorse effectiveness of the frequency, have been available.

### DISCLOSURE OF THE INVENTION

The present invention has been made in view of the foregoing problems, with an object to provide an alerting device capable of producing an alerting tone that does not get drowned out by daily life noises to become inaudible.

To achieve the above object, a first invention of the present invention is an alerting device that outputs an alerting tone having a predominant frequency substantially in a range lower than 3.0 kHz but not lower than 1.5 kHz.

A second invention of the present invention is the alerting device as set forth in the first invention of the present invention, wherein the predominant frequency of said alerting tone is substantially lower than 2.0 kHz.

A third invention of the present invention is the alerting device as set forth in the first or the second invention of the present invention, wherein said alerting tone consists of a single frequency.

A fourth invention of the present invention is the alerting device as set forth in the first or the second invention of the present invention, wherein said alerting tone is constituted of a plurality of sounds, all or a part of which have a mutually different frequency.

A fifth invention of the present invention is the alerting device as set forth in the first or the second invention of the present invention, wherein said alerting tone is constituted of combined sounds having at least one sounding pattern.

A sixth invention of the present invention is the alerting device as set forth in any of the third to the fifth inventions of the present invention, wherein a frequency and/or said sounding pattern of said alerting tone are determined based on a psychological effect.

A seventh invention of the present invention is the alerting device as set forth in the fifth invention of the present invention, wherein said sounding pattern includes a unit having a combination of an ON-period during which said alerting tone is being output and an OFF-period during which said alerting tone is not being output, and said unit is repeated predetermined times.

An eighth invention of the present invention is the alerting device as set forth in the seventh invention of the present invention, wherein at least one of said ON-period, said OFF-period and a frequency of said alerting tone is variable.

A ninth invention of the present invention is the alerting device as set forth in the seventh invention of the present invention, wherein an number of outputting times of said alerting tone in said unit is either an even number or an odd number.

A tenth invention of the present invention is the alerting device as set forth in the seventh invention of the present invention, wherein a number of said predetermined repeating times is variable.

An eleventh invention of the present invention provides an alerting device comprising apparatus connecting means (111) of connecting with another apparatus;

apparatus identifying means (112, 113) of identifying the connected apparatus; and

alerting tone selecting means (112, 113) of selecting the prescribed alerting tone based on a result of the identification, for outputting the alerting tone selected by the alerting tone selecting means.

A twelfth invention of the present invention provides an alerting device comprising external sound acquiring means (101) of acquiring an external sound;

external sound identifying means (55a, 103) of identifying the external sound; and

alerting tone selecting means (55b, 104) of selecting the prescribed alerting tone based on a result of the identification, for outputting the alerting tone selected by the alerting tone selecting means.

A thirteenth invention of the present invention provides the alerting device as set forth in the twelfth invention of the present invention, wherein the identification is performed based on distribution of volume and/or frequency of the external sound.

A fourteenth invention of the present invention provides the alerting device as set forth in the tenth or twelfth invention of the present invention, wherein the prescribed alerting tone selected by the alerting tone selecting means is emitted in different frequencies and/or sounding patterns depending on the purpose of the alerting tone.

A fifteenth invention of the present invention provides an alerting system comprising an alerting device as set forth in the eleventh invention of the present invention; and at least an apparatus (205a˜205b) connected with the alerting device for collaborating with the same.

A sixteenth invention of the present invention provides alerting method utilizing an alerting device capable of outputting a prescribed alerting tone, comprising the steps of:

connecting the alerting device with another apparatus;

identifying the apparatus connected with the alerting device;

selecting the prescribed alerting tone based on a result of the identification, wherein

the alerting device outputs the alerting tone selected in the selecting step.

A seventeenth invention of the present invention provides alerting method utilizing an alerting device capable of outputting a prescribed alerting tone, comprising the steps of:

acquiring an external sound produced outside the alerting device;

identifying the external sound;

selecting the prescribed alerting tone based on a result of the identification, wherein

the alerting device outputs the alerting tone selected in the selecting step.

An eighteenth invention of the present invention provides a program of causing a computer to work as the apparatus connecting means of connecting with another apparatus, the apparatus identifying means of identifying the apparatus connected with the alerting device, and the alerting tone selecting means of selecting the prescribed alerting tone based on a result of the identification, according to the alerting device as set forth in the eleventh invention of the present invention.

A nineteenth invention of the present invention provides a program of causing a computer to work as the external sound acquiring means of acquiring an external sound, the external sound identifying means of identifying the external sound, and the alerting tone selecting means of selecting the prescribed alerting tone based on a result of the identification, according to the alerting device as set forth in the twelfth invention of the present invention.

A twentieth invention of the present invention provides a recorded medium in which the programs according to the eighteenth or nineteenth invention of the present invention are stored, which can be processed by a computer.

Here, the constitution of the present invention is not limited by the numerals given to the respective means defined above.

The present invention as described above facilitates sorting out and distinction of alerting tones flooding in disorder in a home, and allows a user to identify more easily which product is emitting an alerting tone and what message the alerting tone is telling.

The present invention also provides an alerting tone that does not get drowned in daily life noises, but is not only prominently audible to people of extensive age groups including senior aged persons but also comfortable to hear, thereby enabling simplified operation as well as safe, secure and comfortable utilization of electric appliances, which leads to a sensation of enrichment in the daily life.

Utilization of the present invention by an electric appliance designer makes it easier than ever for the designer to achieve an alerting tone that is prominently audible to users of extensive age groups including elderly persons, even though the designer is unable to actually feel an audibility level of an elderly person. Further, designing of an alerting tone more closely adhered to the actual living scene can be executed, rather than merely remaining in a laboratory as before.

### BRIEF DESCRIPION OF DRAWINGS

FIG. 1 is a plan view showing a disposition example of measuring points;

FIG. 2 is a bar graph showing noise levels of various household activities;

FIG. 3(a) is a graph showing a distribution of frequency characteristics and acoustic pressure in various household activities;

FIG. 3(b) is a graph showing a distribution of frequency characteristics and acoustic pressure in various household activities;

FIG. 3(c) is a graph showing a distribution of frequency characteristics and acoustic pressure in various household activities;

FIG. 3(d) is a graph showing a distribution of frequency characteristics and acoustic pressure in various household activities;

FIG. 4(a) is a graph showing a distribution of frequency characteristics and acoustic pressure in various household activities;

FIG. 4(b) is a graph showing a distribution of frequency characteristics and acoustic pressure in various household activities;

FIG. 4(c) is a graph showing a distribution of frequency characteristics and acoustic pressure in various household activities;

FIG. 5(a) is a graph showing a result of the embodiment 4 (background noise and average of audibility threshold);

FIG. 5(b) is a graph showing a result of the embodiment 4 (background noise and average of audibility threshold);

FIG. 5(c) is a graph showing a result of the embodiment 4 (background noise and average of audibility threshold);

FIG. 5(d) is a graph showing a result of the embodiment 4 (background noise and average of audibility threshold);

FIG. 6(a) is a graph showing a result of the embodiment 4 (background noise and average of audibility threshold);

FIG. 6(b) is a graph showing a result of the embodiment 4 (background noise and average of audibility threshold);

FIG. 6(c) is a graph showing a result of the embodiment 4 (background noise and average of audibility threshold);

FIG. 6(d) is a graph showing a result of the embodiment 4 (background noise and average of audibility threshold);

FIG. 7(a) is a graph showing a result of the embodiment 4 (background noise and average of audibility threshold);

FIG. 7(b) is a graph showing a result of the embodiment 4 (background noise and average of audibility threshold);

FIG. 7(c) is a graph showing a result of the embodiment 4 (background noise and average of audibility threshold);

FIG. 7(d) is a graph showing a result of the embodiment 4 (background noise and average of audibility threshold);

FIG. 7(e) is a graph showing a result of the embodiment 4 (background noise and average of audibility threshold);

FIG. 8 is a graph showing distribution average of S/N ratio between an alerting tone and daily life noises;

FIG. 9 is a block diagram showing a constitution of the apparatus 50 according to the embodiment of the present invention;

FIG. 10(a) is a cross-reference table showing correlation of the evaluation scale and a number of repeating times according to the embodiment 1;

FIG. 10(b) is a graph showing correlation of the evaluation scale, a number of repeating times and an extended OFF-period according to the embodiment 1;

FIG. 11(a) is a cross-reference table showing correlation of the evaluation scale and a number of repeating times according to the embodiment 1;

FIG. 11(b) is a graph showing correlation of the evaluation scale, a number of repeating times and an extended OFF-period according to the embodiment 1;

FIG. 12(a) is a cross-reference table showing correlation of the evaluation scale and a number of repeating times according to the embodiment 1;

FIG. 12(b) is a graph showing correlation of the evaluation scale, a number of repeating times and an extended OFF-period according to the embodiment 1;

FIG. 13(a) is a cross-reference table showing correlation of the evaluation scale and a number of repeating times according to the embodiment 1;

FIG. 13(b) is a graph showing correlation of the evaluation scale, a number of repeating times and an extended OFF-period according to the embodiment 1;

FIG. 14(a) is a cross-reference table showing correlation of the evaluation scale and a number of repeating times according to the embodiment 1;

FIG. 14(b) is a graph showing correlation of the evaluation scale, a number of repeating times and an extended OFF-period according to the embodiment 1;

FIG. 15(a) is a cross-reference table showing correlation of the evaluation scale and a number of repeating times according to the embodiment 1;

FIG. 15(b) is a graph showing correlation of the evaluation scale, a number of repeating times and an extended OFF-period according to the embodiment 1;

FIG. 16(a) is a cross-reference table showing correlation of the evaluation scale and a number of repeating times according to the embodiment 1;

FIG. 16(b) is a graph showing correlation of the evaluation scale, a number of repeating times and an extended OFF-period according to the embodiment 1;

FIG. 17(a) is a cross-reference table showing correlation of the evaluation scale and a number of repeating times according to the embodiment 1;

FIG. 17(b) is a graph showing correlation of the evaluation scale, a number of repeating times and an extended OFF-period according to the embodiment 1;

FIG. 18 is a block diagram showing a constitution of the alerting device according to the embodiment 6;

FIG. 19 is a block diagram showing another constitution of the alerting device according to the embodiment 6; and

FIG. 20 is a block diagram showing a constitution of the alerting system according to the embodiment 6.

### REFERENCE NUMERALS

5 IC chip

50 apparatus

51 sound emitting unit

52 amplifier

53 D/A converter

54 sound source generating unit

55 memory unit

### BEST MODE FOR CARRYING OUT THE INVENTION

POLICY OF THE EMBODIMENTS

(1) In each of the following embodiments, particularly an alerting tone of a single frequency (beeping tone) is adopted among various types of alerting tones.

(2) An object of the following embodiments is to provide a detailed designing orientation to be incorporated into development and designing of an alerting device, by revealing data on daily life noises and characteristics thereof, based on psychological influence of an alerting tone pattern to a person and through collection, measurement and analysis of actual daily life noises.

### EMBODIMENT 1

In this embodiment, psychological influence caused in a person by different sounding patterns of an alerting tone is studied.

### EXAMPLE 1

For production of the alerting tone used for the experiment, Town's Gear (a commercial brand, the same applies hereinafter) supplied by FUJITSU FM-TOWNS was adopted, and a sound of an instrument called “piccolo” was employed, which is similar to an alerting tone used in popular apparatus such as a kitchen timer and a public telephone and so forth.

The alerting tones were composed in a form of repeating tones in five sounding patterns, in which a ratio between an ON-period during which the tone was output and an OFF-period during which the tone was not output was respectively set at “1:1”, “2:1”, “2:2”, “3:1” and “3:2”. Then virtual alerting tones were produced by setting the ON-period at five different lengths, namely 2 seconds, 1 second, 0.5 second, 0.25 second and 0.125 second, and 21 levels of such virtual alerting tones, each having different tone lengths and the above-mentioned sounding patterns, were used.

For making up an evaluation scale, the Semantic Differential method (SD method) was employed, which is a typical approach to a psychological assessment. 20 pairs of adjectives describing a tone were selected as evaluation items, and an SD scale classifying the adjective pairs into 7 levels consisting of “not either” in the middle and three levels of “a little”, “considerably” and “very” to both ways was applied to the adjective pairs, and then an evaluation scale table was established by modifying the SD scale items through experiments with subjects.

The subjects were 20 male and 10 female college students. They were subjected to the alerting tones emitted in a random order, to determine an evaluation each time they heard one level.

For the analysis the evaluation data of the seven levels were calculated, and factor analysis has been performed to find out which factor is considered to be more important when evaluating the alerting tone.

As a result, the following has been proven. When designing an alerting tone it has to be taken into consideration that it is important for a user, upon hearing an alerting tone, not only to identify an intrinsic message of the alerting tone such as urging, completion and so on, but also to feel a comfortable sensation, which is free from noisiness or a feeling of disgusting. In other words, it is important to determine a sounding pattern according to a psychological effect caused in a user.

The longer both of the ON-period and OFF-period are, the less psychological sense of urgency the subjects feel, while the shorter the ON-period and OFF-period are the more intensified urging sensation is created. Here, it is to be noted that a slight difference of impression has been observed between the male students and the female students, i.e. the male students tend to feel more comfortable as the ON-period becomes shorter with respect to the OFF-period.

With reference to comfortableness in hearing, a combination of an ON-period of 0.5 to 1 second with an OFF-period of 0.25 to 0.5 second is the most comfortable to male students, and a combination of an ON-period of 0.25 to 0.5 second with an OFF-period of 0.25 to 0.5 second is the most comfortable to female students.

In summary, a sounding pattern composed of an ON-period of 0.5 to 1 second and an OFF-period of 0.25 to 0.5 second is not excessively harsh to a user, and does not cause a dangerous or urgent sensation either. An alerting tone composed of such sounding pattern can give a user a psychological effect such as “I have to hurry” or “Now it's over (sense of relief)” etc. when used for announcing acceptance or completion of an operation i.e. as a sound of confirming operation, or when used for announcing acceptance of a command/start of a function, a temporary stop, a starting point, completion of a function, a mild warning or an erroneous operation.

### EXAMPLE 2

With respect to a continuous alerting tone of a sounding pattern having an ON-period of 1.25 seconds and an OFF-period of 0.125 second, different sound images could be created by changing the number of repeating times and introducing an extended OFF-period, i.e. changing a length of the OFF-period.

For production of the alerting tone used for the experiment, Town's Gear supplied by FUJITSU FM-TOWNS was adopted, and a sound of an instrument called “piccolo” was employed, which is similar to an alerting tone used in popular apparatus such as a kitchen timer and a public telephone and so forth.

The alerting tone was fixed as a continuous sound of a sounding pattern having an ON-period of 0.125 seconds and an OFF-period of 0.125 second, and the number of repeating times of this sounding pattern was set at once, twice, three times, four times, five times and six times, maintaining the OFF-period at 0.125 second in the tone having one repetition but extending the OFF-period to 0.5 second, 1 second and 2 seconds to respectively combine with the ON-period in the tones having two or more repetitions, thus producing 16 levels of prompting sounds. Further, frequency of the alerting tone was set at 2 kHz and 4 kHz, and the alerting tones of the same sounding patterns described above were composed at the respective frequencies.

The subjects were 20 male and 20 female college students, i.e. totally 40 students, for the both alerting tones of 2 kHz and 4 kHz. They were subjected to the alerting tones emitted in random order, to determine an evaluation each time they heard one level.

TABLE 1

| number of | | | |
|---|---|---|---|
| repeating times | extended OFF-period | | |
| Once | 0.125 | | |
| twice | 2 | 1 | 0.5 |
| 3 times | 2 | 1 | 0.5 |
| 4 times | 2 | 1 | 0.5 |
| 5 times | 2 | 1 | 0.5 |
| 6 times | 2 | 1 | 0.5 |

With reference to the evaluation scale, an evaluation scale of 7 levels was adopted for 12 items shown in Table 2, focusing on accuracy in measurement of impression of the alerting tones and ease in evaluation by the subjects.

TABLE 2
evaluation scale table

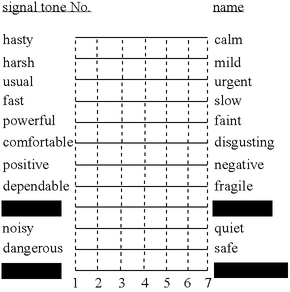

For the analysis the evaluation data of the seven levels were calculated, and factor analysis has been performed to find out which factor is considered to be more important when evaluating the alerting tone.

As a result, the following has been proven. It has been discovered that a sounding pattern that includes an extended OFF-period of 1 second is effective to operate a sense of urgency with keeping appropriate comfortableness with respect to an alerting tone.

A sounding pattern that has an extended OFF-period is more effective in operating a certain image. It is therefore effective to set an extended OFF-period depending on the purpose of the alerting tone.

(1) For intensifying the urging sensation

Set an extended OFF-period not longer than 1 second

Increase the number of repeating times (effective with an extended OFF-period not shorter than 1 second, however the effect remains the same with five or more repetitions)

It is more effective to set a longer extended OFF-period than increasing the number of repeating times.

(2) For reducing urging sensation

Set an extended OFF-period not shorter than 1 second

Reduce the number of repeating times (effective with an extended OFF-period not shorter than 1 second)

Set an even number of repeating times (effective with an extended OFF-period not shorter than 1 second, however as the number of repeating times increases to twice, fourth times, six times and so forth, the effect is diluted)

It is more effective to set a longer extended OFF-period than increasing the number of repeating times.

(3) For increasing comfortableness

Set an extended OFF-period not shorter than 1 second (There is little difference between 1 and 2 seconds.)

Reduce the number of repeating times (twice is particularly effective, then comes four times)

It is more effective to set a longer extended OFF-period than increasing the number of repeating times.

(4) With an extended OFF-period of 2 seconds, sufficient comfortableness is obtained but urging sensation is not adequate regardless of varying the number of repeating times.

An extended OFF-period of 0.5 second provides sufficient urging sensation, but accompanied with disgusting sensation.

An extended OFF-period of 1 second creates a sensation that is neither comfortable nor disgusting.

Accordingly, prolonging the extended OFF-period can reduce the urging sensation and the disgusting sensation.

(5) Effect of the number of repeating times depends on a length of the extended OFF-period, and the shorter the extended OFF-period becomes the less psychologically significant the number of repeating times becomes.

When the extended OFF-period is 2 seconds, an increase of the number of repeating times provides a stronger urging sensation (though it does not apply to five times or more) while when the extended OFF-period is not longer than 1 second the number of repeating times barely makes difference.

(6) Effect of the number of repeating times. Setting an even number or an odd number of repeating times can provide different degree of urging sensation. An even number of repeating times provides less psychological sense of urgency and disgusting feeling than an odd number does.

As described above, it is possible to give the alerting tone an integrated psychological image, by determining a sounding pattern having an appropriate combination of the ON-period and OFF-period, for the respective categories defining whether psychological sense of urgency should be created or not.

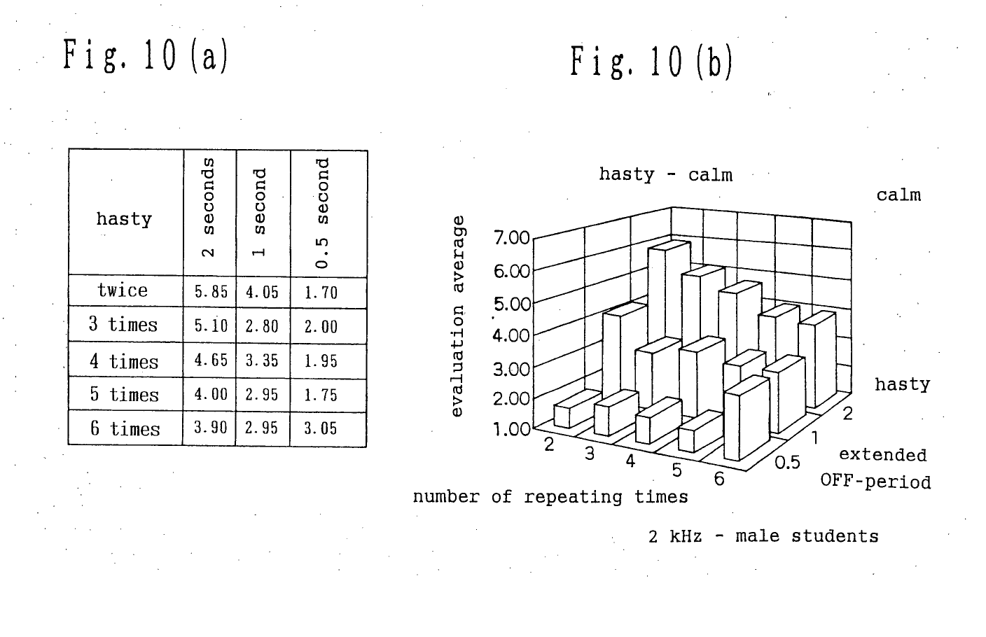

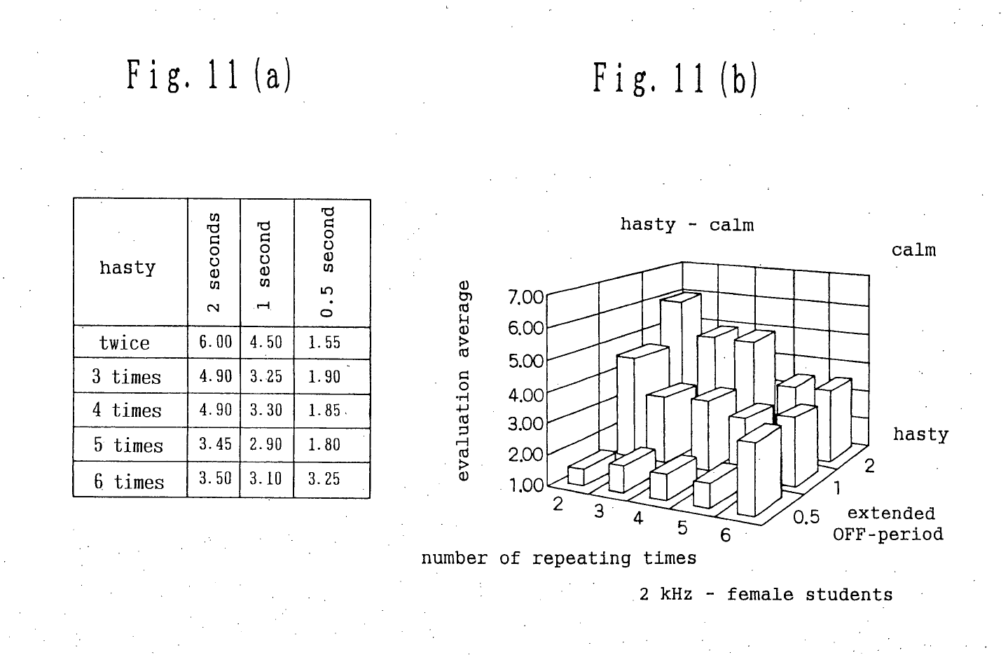

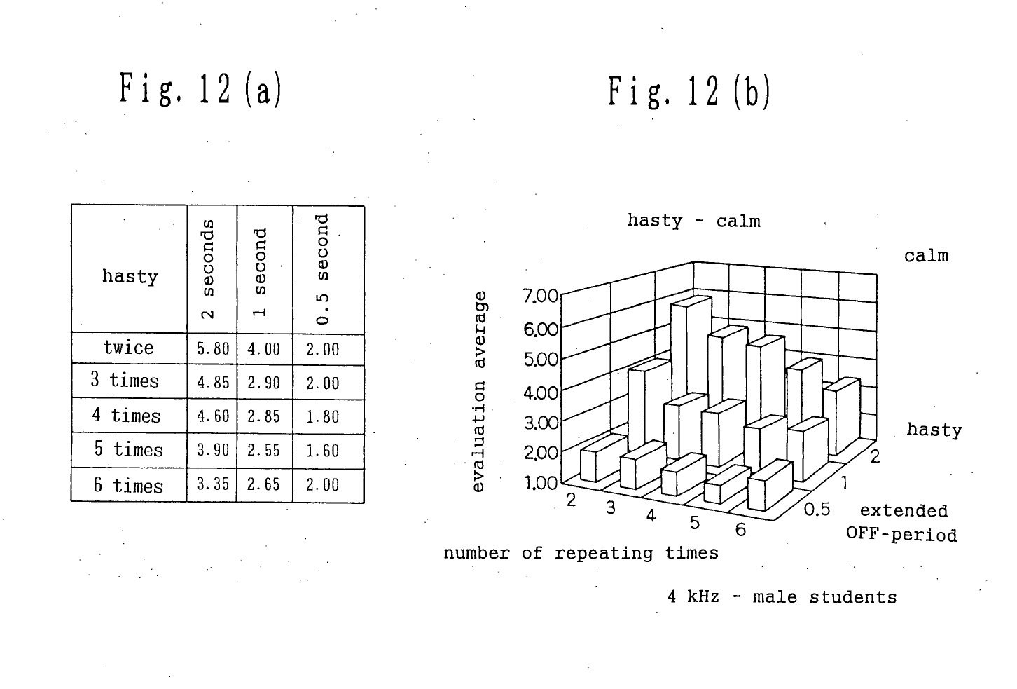

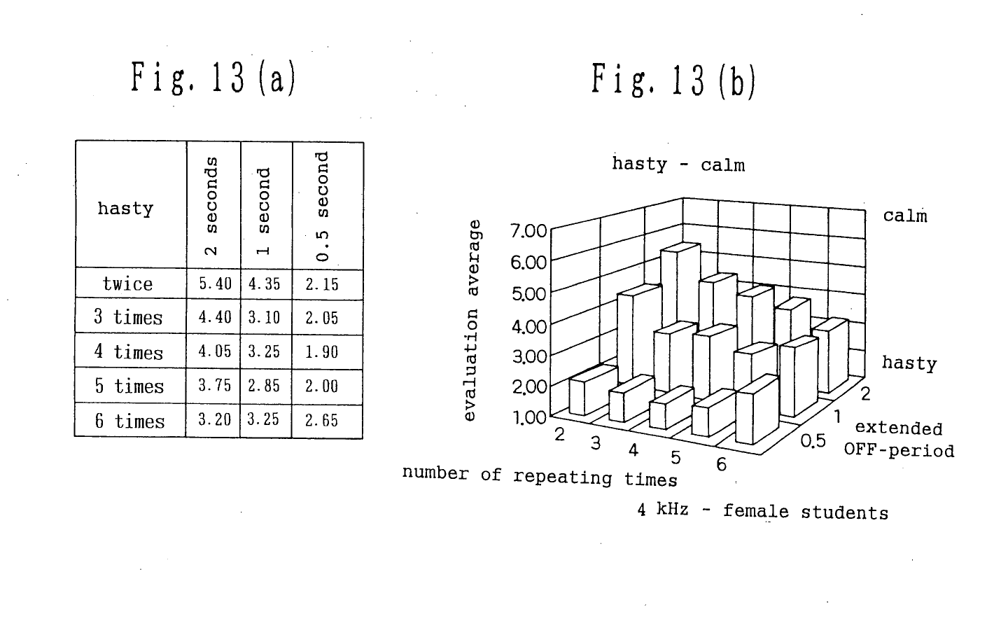

Also, results of similar experiments to that described above, in which an adjective pair of “hasty-calm” was picked up as an example out of the evaluation items shown in the table 2 are shown in cross-reference tables and graphs according to FIGS. 10 (a), 10(b) through 13(a), 13(b). Here, FIGS. 10(a), 10(b), 12(a), 12(b) represent data of the male students, and FIGS. 11(a), 11(b), 13(a), 13(b) represent data of the female students.

As shown in these tables and graphs, the alerting tone having an extended OFF-period of 2 seconds provides increased hasty sensation with the increase of the number of repeating times, while in case of the tones having an extended OFF-period of 1 second or 0.5 second influence of increase or decrease of the number of repeating times is not significant.

As a whole, the shorter the extended OFF-period becomes, the more the hasty sensation is emphasized. When the tones are repeated four times or six times, the hasty sensation is reduced. Difference due to the frequency of the alerting tone has not been remarkably observed.

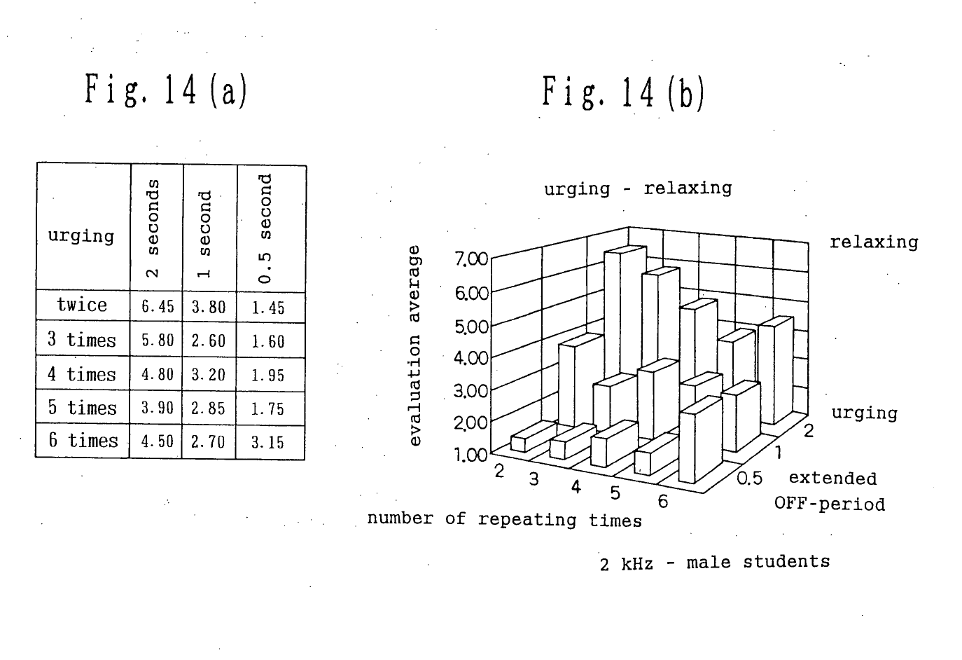

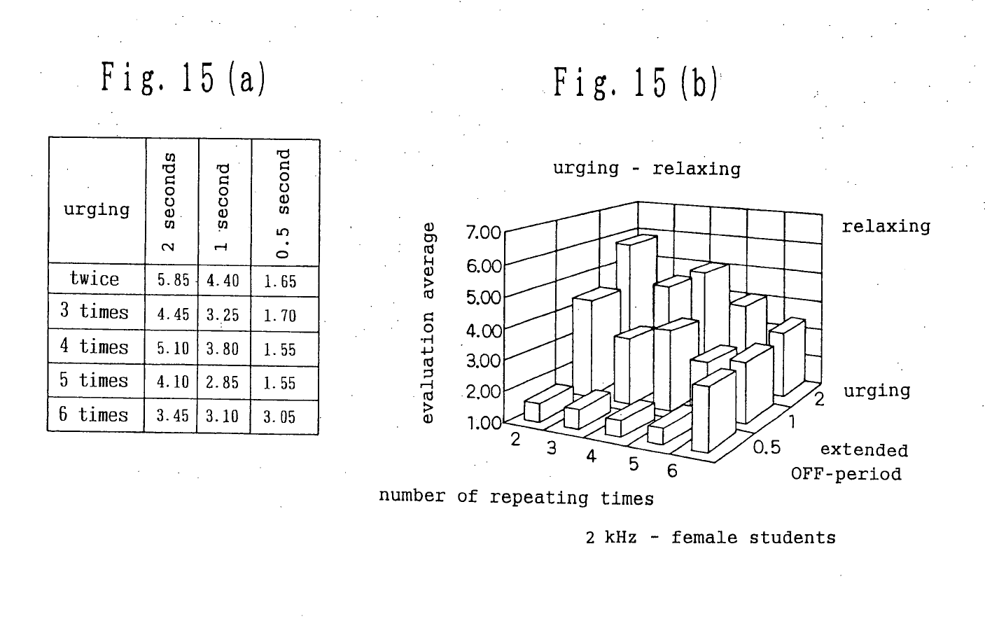

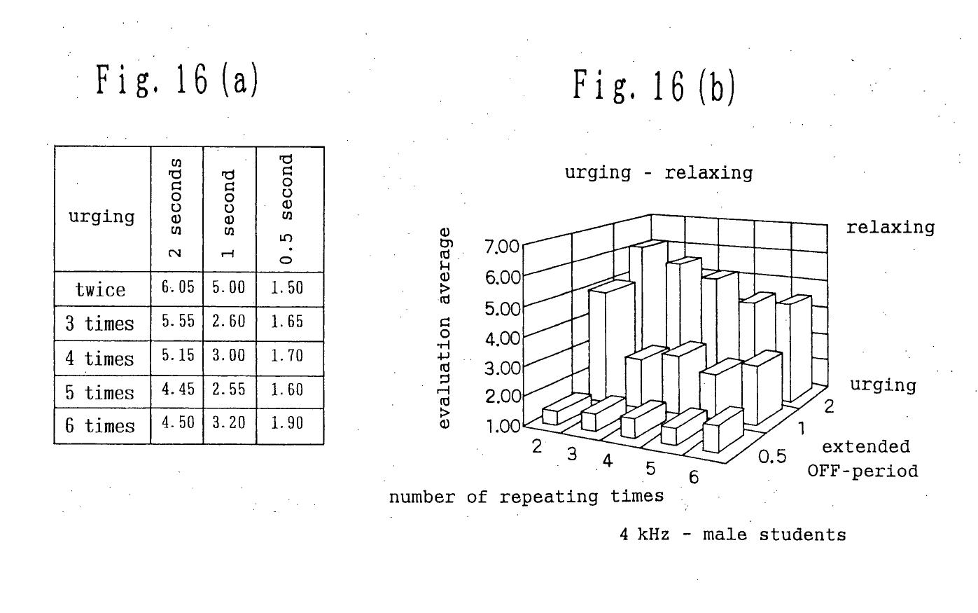

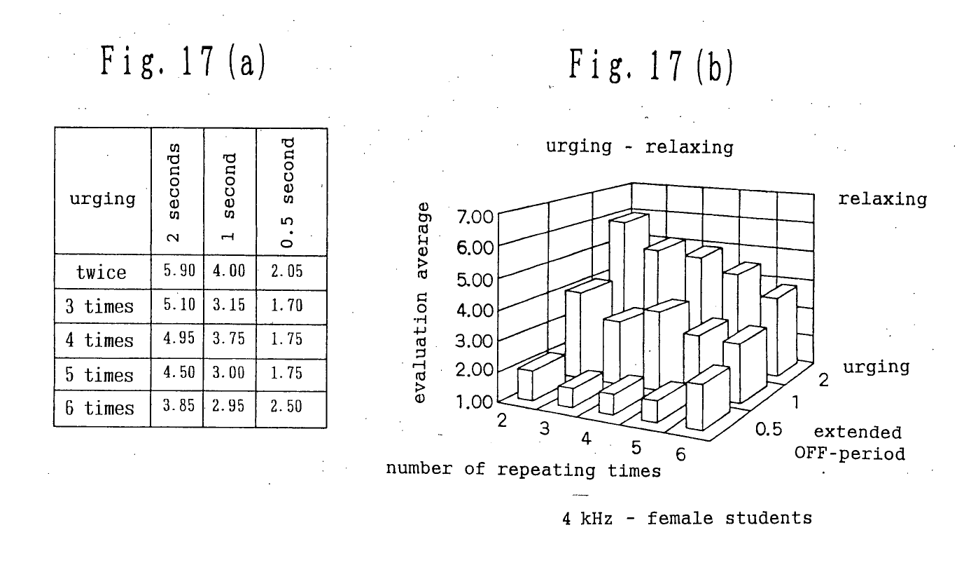

Further, results of similar experiments to that described above, in which an adjective pair of “urging-relaxing” was picked up as an example are shown in cross-reference tables and graphs according to FIGS. 14(a), 14(b) through 17(a), 17(b). Here, FIGS. 14 (a), 14(b), 16(a), 16(b) represent data of the male students, and FIGS. 15 (a), 15(b), 17(a), 17(b) represent data of the female students.

As shown in these tables and graphs, the alerting tone having an extended OFF-period of 2 seconds is prominently susceptible to the number of repeating times, and the urging sensation is more intensified with the increase of the number of repeating times.

On the contrary, the alerting tone having an extended OFF-period of 0.5 second barely makes difference depending on the number of repeating times, and besides, is providing intense urging sensation.

In the case of the frequency of 4 kHz, difference between the male and female students is not remarkably observed, however with the frequency of 2 kHz the female students tend to feel more relaxing.

In this case too, when the tones are repeated four times or six times, the hasty sensation is reduced.

As described above, it is possible to give the alerting tone an integrated psychological image, by determining a sounding pattern having an appropriate combination of the ON-period and OFF-period, according to psychological conditions.

### EMBODIMENT 2

In this embodiment, psychological influence caused by difference in frequency of the alerting tone is studied.

### EXAMPLE 3

For production of the alerting tone used for the experiment, Town's Gear supplied by FUJITSU FM-TOWNS was adopted, and a sound of an instrument called “piccolo” was employed, which is similar to an alerting tone used in popular apparatus such as a kitchen timer and a public telephone and so forth.

The alerting tone was fixed as a continuous sound of a sounding pattern having an ON-period of 0.125 second and an OFF-period of 0.125 second, and the number of repeating times of this sounding pattern was set at once, twice, three times, four times, five times, six times and none, maintaining the OFF-period at 0.125 second in the tone having one repetition (0 second for non-repeating tone) but extending the OFF-period (length of OFF-period) to 0.5 second, 1 second and 2 seconds to respectively combine with the ON-period in the tones having two or more repetitions, thus producing 17 levels of alerting tones. Further, frequency of the alerting tone was set at 1 kHz, 2 kHz and 4 kHz, and the alerting tones of the same sounding patterns described above were composed at the respective frequencies.

The subjects were 20 male and 20 female college students, i.e. totally 40 students. They were subjected to the alerting tones emitted in random order, to determine an evaluation each time they heard one level.

Based on the evaluation results obtained through the experiment with the subjects, a score from 1 to 7 was given with respect to the evaluation items, and average scores were worked out.

As a result, the following has been proven.

(1) It has been discovered that an alerting tone of 1 kHz is less susceptible to difference of extended OFF-period or number of repeating times than that of 2 kHz and 4 kHz.

(2) Alerting tones of 2 kHz and 4 kHz scarcely causes difference in psychological influence as long as they are prompting tones having the same sounding pattern.

(3) When composing an alerting tone using a sound of a frequency close to 1 kHz, the following points must be taken into account.

As the extended OFF-period becomes longer, urging sensation is reduced and comfortableness is increased. (However, in case where a tone of 1 kHz is composed in the same sounding pattern as that of a tone of 2 kHz or 4 kHz, the 1 kHz tone has rather stronger urging sensation and uncomfortable feeling.)

As the extended OFF-period becomes shorter, both the urging sensation and disgusting feeling are intensified. (However, in case where a tone of 1 kHz is composed in the same sounding pattern as that of a tone of 2 kHz or 4 kHz, the 1 kHz tone provides less urging sensation and more comfortableness.)

Difference in the number of repeating times is not significant.

A female person tends to feel less urged and less disgusting than a male does.

Also, an alerting tone of 1 kHz is neither more comfortable nor more disgusting than a tone of 2 kHz or 4 kHz.

(4) An alerting tone of 1 kHz having an extended OFF-period of 0.5 second tends to provide less urging sensation and less disgusting feeling than that of 2 kHz or 4 kHz. And as in the case of 2 kHz or 4 kHz, difference in the number of repeating time tends to less significant.

(5) An alerting tone of 1 kHz having an extended OFF-period of 2 seconds tends to provide more urging sensation and disgusting feeling than that of 2 kHz or 4 kHz.

As described in the embodiment 2, it is possible to give the alerting tone an integrated psychological image, by setting an appropriate frequency for the respective categories defining whether psychological sense of urgency should be created or not.

### EMBODIMENT 3

(1) Collection, Measurement and Analysis of Daily Life Noises; Sampling of Subject Families

In this embodiment, actual measurement of frequency characteristics of environmental noises caused by various household activities was executed. Specifically, the actual measurement was performed at the monitors of 16 houses for Matsushita Electric Industries Co., Ltd., living in an area between Kyoto and Osaka.

As a preliminary investigation, a questionnaire was distributed to 163 monitor family candidates to obtain information on problems that they regularly feel about an alerting tone as well as structural conditions related to a sound field in the house. Then 16 families were selected out of the 163, such that the subject group would consist of houses that have various types of room structure and layout.

(a) Measurement of Acoustic Pressure Level Distribution in the Dining Kitchen

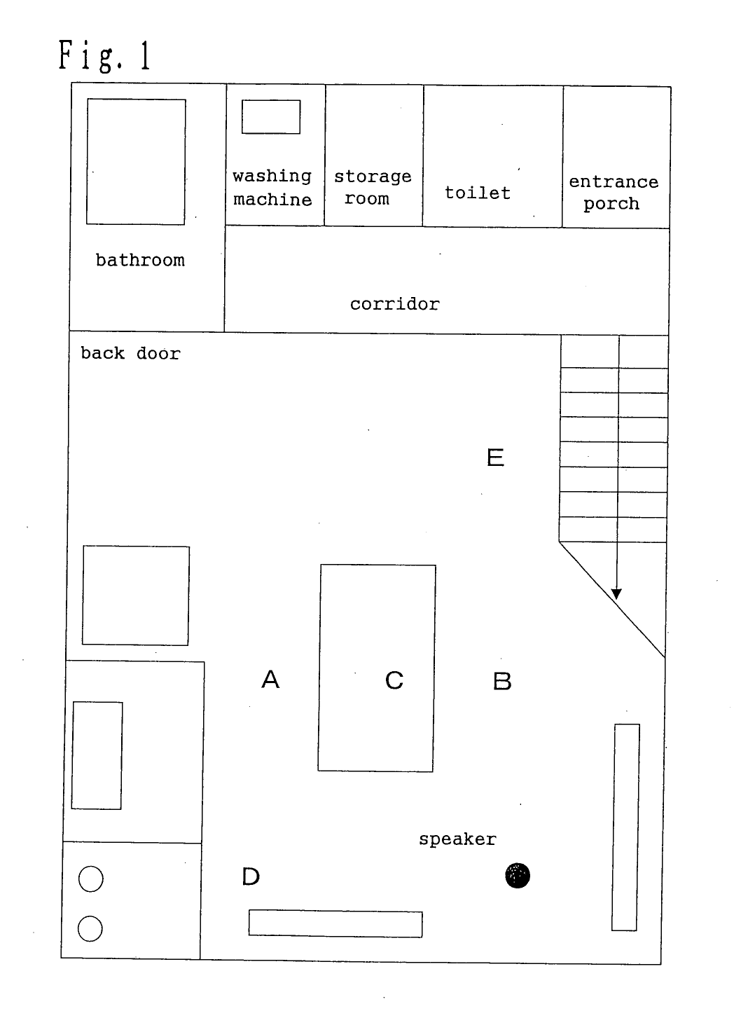

Since a sound level varies depending on a hearing location, measurement was performed to obtain an outline of dispersion of sound volume at different locations in a room, prior to the measurement of home life noises. Five points (A through E) in the dining kitchen were selected as measuring points (FIG. 1). The point A is at a central region of the kitchen and close to a location for cooking operation; B is at a central region of the dining space; C is the middle point between A and B; and D and E are located at a corner of the kitchen. As a sound source a 1/1-octave band noise (recorded in a CD for audio equipment checking) was used, and the sound was emitted from a speaker directed toward a corner of the room. With reference to frequencies to be measured, a continuous single tone of four frequency bands namely 500 Hz, 1 kHz, 2 kHz and 4 kHz, which were presumed to have substantial influence to masking effect of an alerting tone, was emitted for three seconds, and such sound was measured three times and an average value was worked out with respect to each measuring point, to examine how the sound would diffuse in the room.

(b) Measurement of Daily Life Noises

Noises to be measured were taken from six daily life scenes listed in the table 3, which were often performed in a home to create the daily life noises, and most likely to impede a family member from hearing an alerting tone. In addition, an alerting tone of each single apparatus was also measured.

TABLE 3

| | | measuring sound |
|---|---|---|
| life scene | description | receiving point |
| cooking operation | vegetable | central region of |
| | stir-frying, | the kitchen |
| | ventilating fan, | |
| | rice cooker, | |
| | microwave oven, | |
| | electric jar pot | |
| dish washing | hand washing, dish | central region of |
| | washer | the dining space |
| television watching | usual volume | distance: 1 meter at |
| | volume while | the front |
| | ventilating the | height: 1 meter |
| | kitchen | |
| room cleaning | operating noise | distance: 1 meter |
| | close to the cleaner | from the center of |
| | | the cleaner |
| | | height: 1 meter |
| | operating noise at | distance: 1 meter |
| | the ear of the user | from the center of |
| | | the cleaner |
| | | height: at the ear of |
| | | the user |
| washing | spin-drying right | distance: 1 meter |
| | before finishing | from the center of |
| | (with the cover | the cleaner |
| | closed) | height: 1 meter |
| others | clothes drying | distance: 1 meter |
| | machine, stereo | from the center of |
| | player, piano | the cleaner |
| | | height: 1 meter |
| single alerting | rice cooker, | distance: 1 meter |
| tone | microwave oven, | from the center of |
| | electric jar pot, | each apparatus |
| | dish washer, | height: at a level of |
| | refrigerator, | the front part of |
| | kitchen timer, oven | each apparatus |
| | toaster, telephone, | |
| | interphone, washing | |
| | machine | |

For the purpose of measurement, the families were requested to perform the mentioned seven types of household activities in a manner that is usual in their respective homes, and noises thereby generated were recorded. Specifically, a noise level meter used as a microphone was disposed at a central point at the kitchen side and a central point at the dining space side respectively, and DAT was used as the recording medium. Alerting tones and operating noises from the respective apparatus themselves in the corresponding household activities were also recorded, in which case the sound was recorded at a distance of 1 meter from a front of the apparatus.

(2) Measurement Result of Acoustic Pressure Distribution in the Dining Kitchen

According to the measurement of differences between a maximum value and a minimum value from the measuring points A to E in each monitored family, an average difference of 6 to 8 dB was observed, with a maximum difference of 12 dB.

(3) Comparison of Noise Level of Daily Life Noises

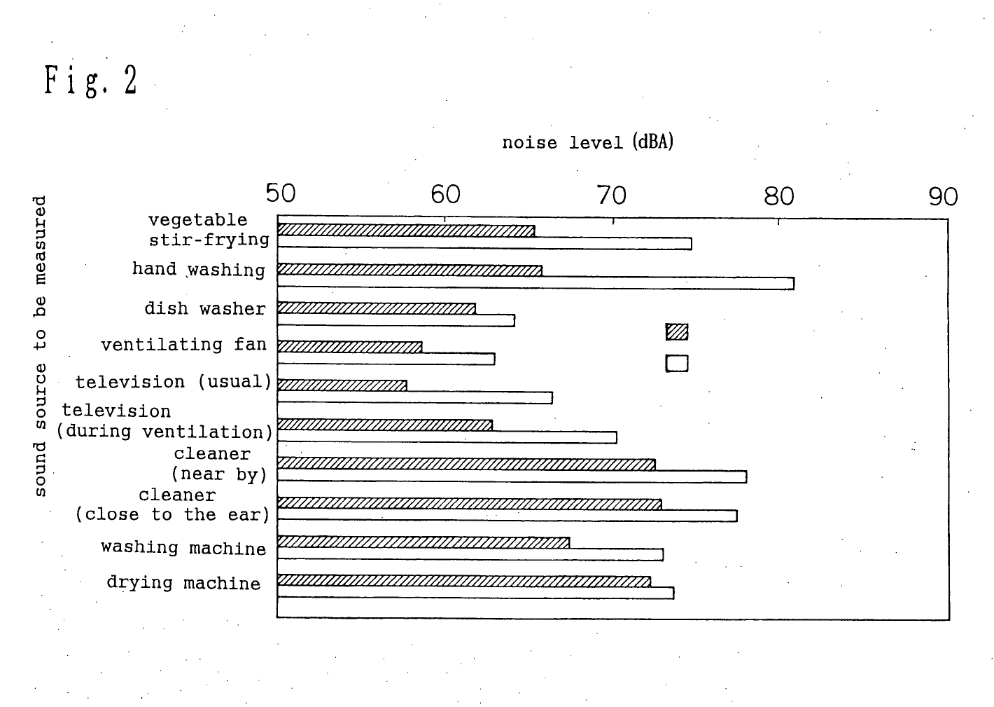

Average values of data obtained from the monitored families with respect to equivalent noise level (Leq) and peak noise level (Lmax) of the respective household activities FIG. 2).

In cooking operation (stir-frying vegetables) and hand washing, a large difference between a equivalent noise level and a peak noise level was observed, therefore the noise generated by these activities has a large level fluctuation range. In the case of cooking, it is considered to be because the noise contains a substantial amount of impulsive noise component, such as splashing noise of oil and metallic noise from the frying pan. Cleaners, washing machines and drying machines generate a noise of a large volume, therefore the noise from these apparatus occupy a considerable portion of the daily life noises in a home.

(4) Result of Analysis of Frequency of the Daily Life Noises

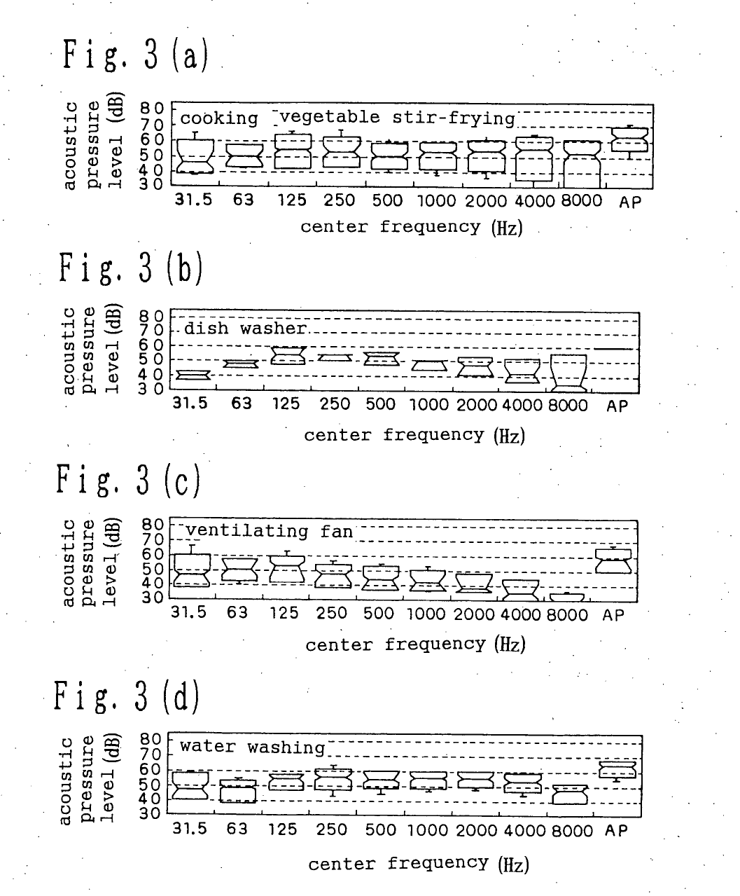

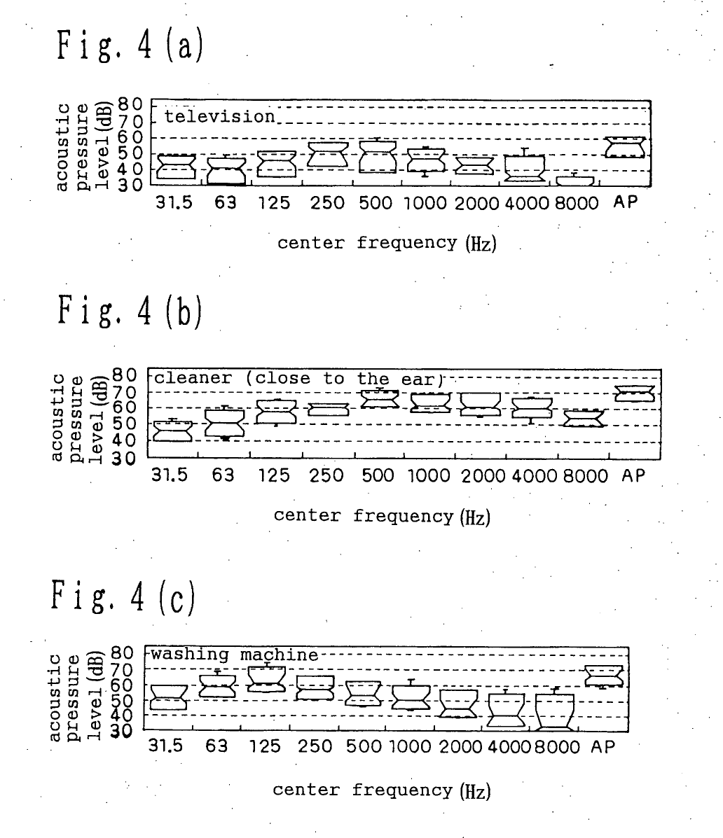

The daily life noises recorded in the respective household activities were subjected to frequency analysis by 1/1 octave band. Each of the noises were analyzed for 10 seconds by five times, and an average value has been worked out. Volume distribution in different frequency bands is shown in FIGS. 3(a) to 3(d) and 4(a) to 4(c). A horizontal line at a central portion of each box in the box and whiskers plot shows a median, whiskers show a maximum and a minimum value, and ends of each box show 10% and 90% respectively. The constricted portion of the box shows an upper and lower 25 percentile point.

According to the analysis result, “vegetable stir-frying” and “hand washing” had wide frequency characteristics in a medium to high range of 500 to 4000 Hz. Noise of flowing water and contacting noises of metallic and plastic objects such as cooking devices are considered to be the basic sound source.

Ventilating fans and washing machines had a peak around 125 Hz, because of the rotating noise of the motor. However, in case of a ventilating fan enclosed in a range hood, a noise that seemed to be a wind noise was considerably loud, and another peak was observed around 63 Hz.

Also, cleaners caused a loud motor noise because of high-speed rotation, besides which they caused friction noises with the floor and wind noises, resulting in extensive frequency characteristics in the medium to high range. Further, through an analysis of frequency distribution by FFT (Fast Fourier Transform) with respect to alerting tones of the apparatus utilized in the respective monitored families, it has been discovered that a majority of the alerting tones have a basic frequency in a range of 2 kHz to 4 kHz.

### EMBODIMENT 4

A frequency easily identifiable even by elderly people has been sought for, in consideration of the daily life noises.

For the experiment 13 levels of daily life noises recorded and analyzed through six kinds of household activities, and five frequency levels of alerting tones namely 1.0 kHz, 1.5 kHz, 2 kHz, 3 kHz and 4 kHz were used in combination, i.e. totally 65 kinds of alerting tones were employed.

TABLE 4

| daily life noises (13 levels) | alerting tones (5 levels) |
|---|---|
| cleaner (2 levels) | 1.0 kHz |
| vegetable stir-frying | 1.5 kHz |
| television (2 levels) | 2 kHz |
| stereo player | 3 kHz |
| piano (2 levels) | 4 kHz |
| electric jar pot | |
| dish washing by hand | |
| washing machine | |
| ventilating fan | |
| dish washer | |

As the alerting tones, pure tones digitally synthesized on a personal computer were utilized.

The alerting tone was composed in a sounding pattern consisting of five repetitions of an ON-period of 0.1 second and an OFF-period of 0.1 second. A slight slope was added at a rising edge and falling edge of the alerting tone, so that a subject would not perceive a click noise. Such alerting tones were presented in the midst of the daily life noises.

Also, the daily life noises were taken from those generated in the daily life in a home, and 13 levels were selected including noises from a single source measured in different levels, taking difference of apparatus or situation of use into consideration.

For the daily life noises, those recorded in actually existing homes were employed.

With reference to the experiment method, method of adjustment by subject was adopted to obtain audibility threshold of each subject.

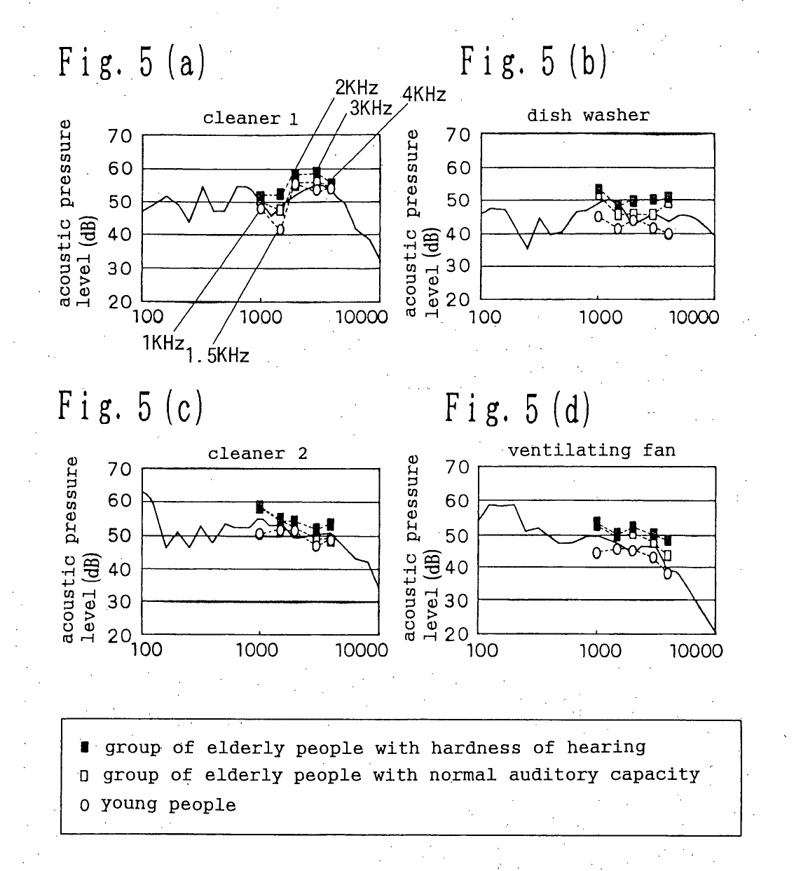

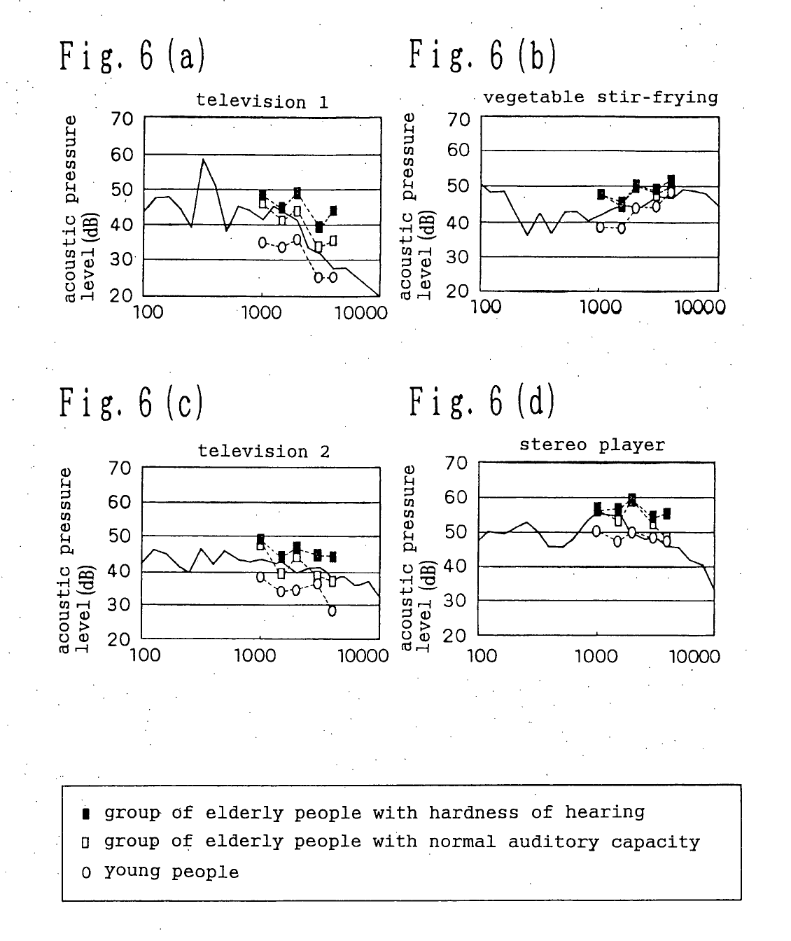

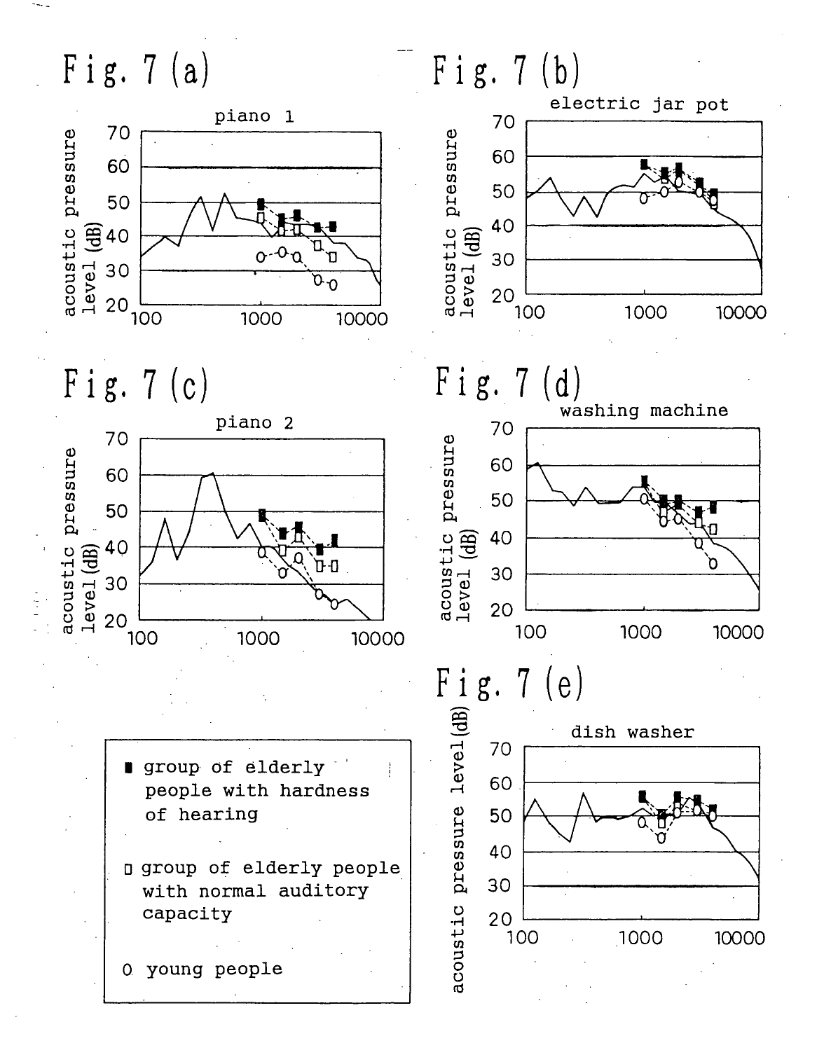

(1) Frequency characteristics could be broadly divided into three levels, despite the fact that the audibility threshold was considerably different depending on the frequency characteristics of the daily life noises. Results of the daily life noises and averages of audibility threshold are shown in the graphs of FIGS. 5(a) to 5(d), 6(a) to 6(d) and 7(a) to 7(e). By the way, in each of the graphs a black square represents a group of elderly people with hardness of hearing, a white square represents a group of elderly people with normal auditory capacity and a white circle represents young people.

(2) Under the loud daily life noises containing a high frequency, such as the cleaner level 2, the ventilating fan, the electric jar pot and the stereo player, alerting tones of all the frequency levels were similarly masked, among which an alerting tone of 3 kHz to 4 kHz was evaluated to be easier to identify, though dispersion was considerably large.

(3) Under the noises of the cooking operation (vegetable stir-frying), the dish washing by hand, the dish washer and the cleaner level 1 masking effect was greater against alerting tones of a high range, and an alerting tone around 1. 5 kHz was evaluated to be easier to identify.

(4) Under the noises of the washing machine, the television (levels 1 and 2), and the piano (levels 1 and 2) the alerting tones were more prominently masked in the medium to low range, and an alerting tone around 3 kHz was evaluated to be easier to identify.

Accordingly, in consideration of the masking effect by the daily life noises, it is preferable that an alerting tone has a frequency in a range of 1.5 kHz to 3 kHz.

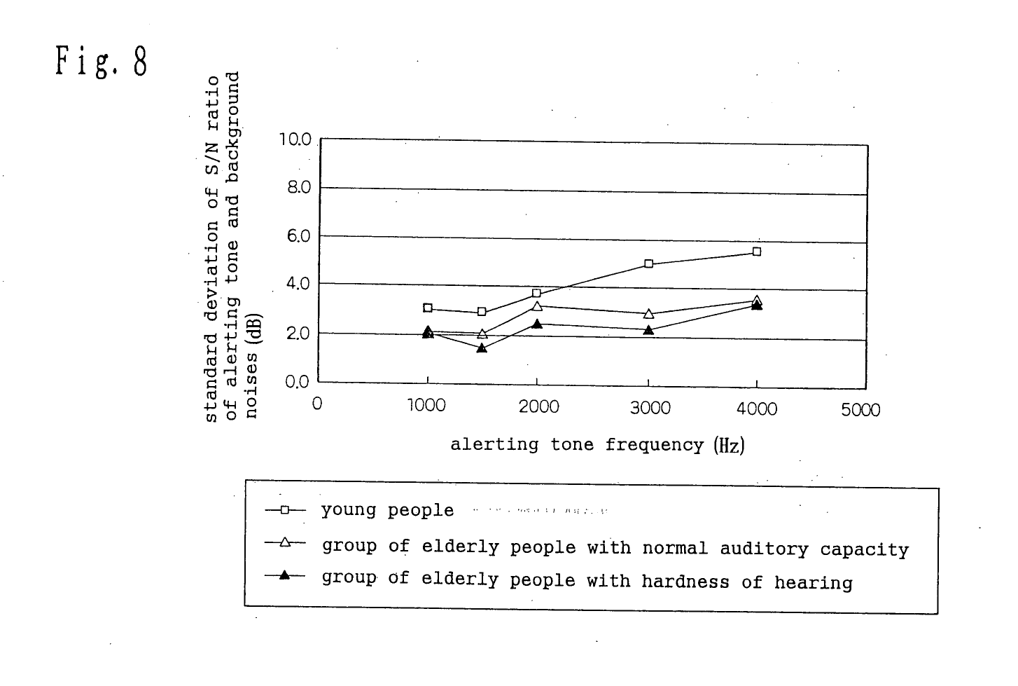

Now, FIG. 8 is a graph showing averages of S/N ratio distribution of the alerting tones and daily life noises with respect to the tones of all the frequencies used in the experiment. The graph shows dispersion of difference between a threshold of an alerting tone audible to a person and the daily life noises (axis of ordinate) with respect to each frequency of the alerting tone (axis of abscissa) As the S/N ratio value increases, it becomes more difficult to identify the alerting tone unless an acoustic pressure of the alerting tone is greater than the daily life noises. From an opposite viewpoint, the smaller a value of the axis of ordinate is, the easier it becomes to identify the alerting tone.

According to the graph of FIG. 8, the dispersion between young people and the groups of elderly people, including both with hardness of hearing and with normal auditory capacity, when the alerting tone is at 2 kHz.

On the other hand, the dispersion is greater in the range exceeding 2 kHz up to 4 kHz, than in the range not higher than 2 kHz. Besides, a value of the axis of ordinate is greater in a higher frequency range, with respect to all the subject groups.

In view of the above, it has been discovered that a dispersion of a subject's recognition as to whether he or she can identify an alerting tone is substantially great depending on the subject, with respect to an alerting tone of a high frequency exceeding 2 kHz.

For example in case where a frequency of an alerting tone is 3 kHz, adjusting the acoustic pressure of the alerting tone according to auditory capacity of elderly people makes young people feel it noisy, and on the contrary setting the acoustic pressure of the alerting tone according to auditory capacity of the young people impedes the elderly people from identifying the alerting tone. Therefore it is difficult to obtain an alerting tone similarly identifiable by both the elderly and young people.

By contract, when a frequency of the alerting tone is 2 kHz or lower, the dispersion of the S/N ratio of the alerting tone and the daily life noises is smaller among the subjects. In other words, it is easy to obtain an alerting tone similarly identifiable by both the elderly and young people. Besides, a value of the S/N ratio is small. Therefore, an alerting tone of a certain volume is easily identifiable to all the subject groups, regardless of the circumstances in which the alerting tone is emitted.

As a result of the foregoing, a frequency substantially in a range lower than 2 kHz but not lower than 1.5 kHz is the most preferable, as a frequency of an alerting tone similarly identifiable to both elderly and young people, in consideration of the daily life noises. Also, as already described, solely from the viewpoint of the daily life noises, the frequency can be substantially in a range from 1.5 kHz to not greater than 3 kHz, applying the aforementioned conditions as the case maybe, depending on the circumstances in which the alerting tone is to be used.

### EMBODIMENT 5

Evaluation of identifiability of alerting tones (home monitor test) was executed in an actual life of an existing family, utilizing a commercially available electric appliance (a microwave oven) as an alerting apparatus that emits alerting tones according to those conditions described in the embodiment 4.

(1) Results of the Home Monitor Test

Since in many cases a person is doing some household work close to the microwave oven during a use of the same, it was rare that the alerting tone was not noticed. According to the result of the test the alerting tone of a frequency of 2 kHz was the most preferred, followed by that of 1.5 kHz and of 3 kHz in this sequence. However, for some of the people with hardness of hearing it was difficult to identify the alerting tone of 3 kHz, and some of such people didn't notice at all the alerting tone of 4 kHz.

Also, from the viewpoint of impression, the alerting tone of 4 kHz and 1 kHz were unfavorably noted, because the former was too sharp, and on the contrary the latter was uncomfortable to hear because of its low key.

(2) Review of the Home Monitor Test Results by the Subjects in the Laboratory

Alerting tones of the frequency of 2 kHz and 3 kHz were more favorably evaluated than those of the other frequencies, except people with serious hardness of hearing. For the people with hardness of hearing, it was difficult to identify the alerting tones of 3 kHz and 4 kHz, even when examined without the daily life noises, i.e. with the alerting tone alone. With the daily life noises, the alerting tones of 1.5 kHz and 2 kHz enjoyed favorably evaluation regardless the type of the daily life noises.

Accordingly, it has been proven through the examination in the actual living scene that an alerting tone of a frequency substantially in a range not lower than 1.5 kHz and not higher than 2 kHz is easy to identify for people of extensive generations including elderly people, in a circumstances where the daily life noises are generated.

### EMBODIMENT 6

In the embodiments 4 and 5, data of the daily life noises were measured, and it has been proven which frequency is the most preferable as an alerting tone, under a circumstance where the daily life noises exist.

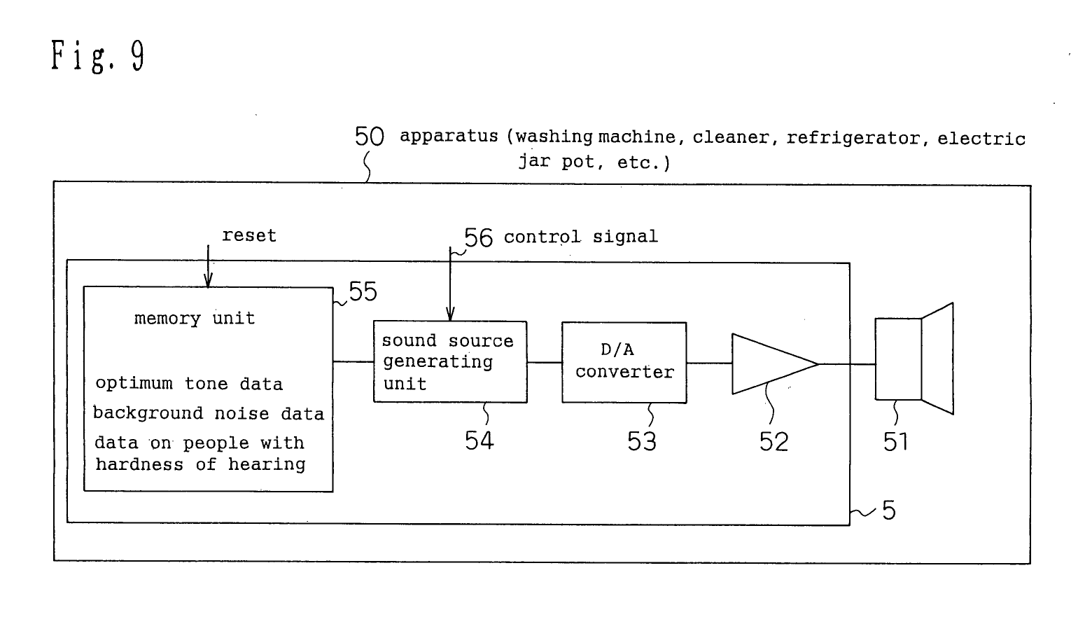

Now referring to FIG. 9, a working example of incorporation of an alerting device according to the present invention into various apparatus mainly home electric appliances will be described, based on the foregoing experimental data.

FIG. 9 is a block diagram showing a constitution of an apparatus, provided with an alerting device because of incorporating an alerting device according to the present invention. Also, though the apparatus herein stands for various home electric appliances such as a washing machine, a cleaning robot, a refrigerator, an electric jar pot, a microwave oven, an iron and so forth, the apparatus applicable to the present invention are not limited to those cited. Examples of the apparatus further include information communication apparatus such as a telephone and a facsimile transmitter/receiver, OA (office automation) apparatus such as an electronic calculator and a personal computer, combustion apparatus such as an oil fan heater, toys such as an electric toy, housing appliances such as a hot water supply system for a bathroom, cameras such as a digital camera, health and welfare apparatus such as an electronic manometer and so forth.

Referring to FIG. 9, the reference numeral 5 denotes an IC of controlling a sound source, responsible for the alerting function of the apparatus to be controlled, and is usually constituted of a single chip. The IC 5 may also be constituted of two or more chips. Further, the function can be programmed as software of a personal computer.

Numeral 51 stands for a sound emitting unit of receiving an output of the IC 5 and converting the output into an actual acoustic wave, constituted of a speaker, a piezoelectric buzzer, vibrating plate, etc.

Numeral 52 stands for an amplifier of amplifying sound source data so that the sound emitting unit can receive a sufficient output; 53 stands for a D/A converter of converting the digitally processed sound source data into an analog signal; 54 denotes a sound source generating unit of deciding which sound source to generate; and 55 denotes a non-volatile memory unit, which can be constituted of a flash memory, an EEPROM, or a magnetic RAM, etc. In the memory unit 55, for example data of the daily life noises collected in a manner described in the embodiment 5, data of masking effect in the daily life noises, data of frequency characteristics of the people with hardness of hearing, etc. are stored.

Operation of the apparatus 50 constituted as above according to the present embodiment will be described hereunder.

The sound source generating unit 54 of the IC 5 selects a sound source to generate, according to a control signal 56 from the apparatus 50.

The sound source generating unit 55 utilizes the background noise data stored in the memory unit 55, so as to generate an optimum alerting tone data (hereinafter simply referred to as “optimum tone data”) in a circumstance in which, when the apparatus 50 is an washing machine for example, the washing machine is to be used. The generated data can be retrieved out of the memory unit 55 once the data is stored therein. The selected optimum tone data is converted into analog data by the D/A converter 53, amplified by the amplifier 52, to be finally emitted as an alerting tone from the sound emitting unit 51.

In this way, an optimum alerting tone for the respective apparatus can be generated.

And, according to the foregoing detailed examples, the optimum alerting tone is in a range lower than 2 kHz but not lower than 1.5 kHz in the case of using under the daily life noises.

Further, according to the present embodiment the daily life noises are stored in advance in the memory unit 55, however it is also possible to install a microphone for measuring background noises in the respective apparatus, so that the microphone measures the surrounding background noises upon being purchased or when the environment of use has changed and provides a reset signal to the memory unit 55 to input the updated data, to thereby rewrite the data.

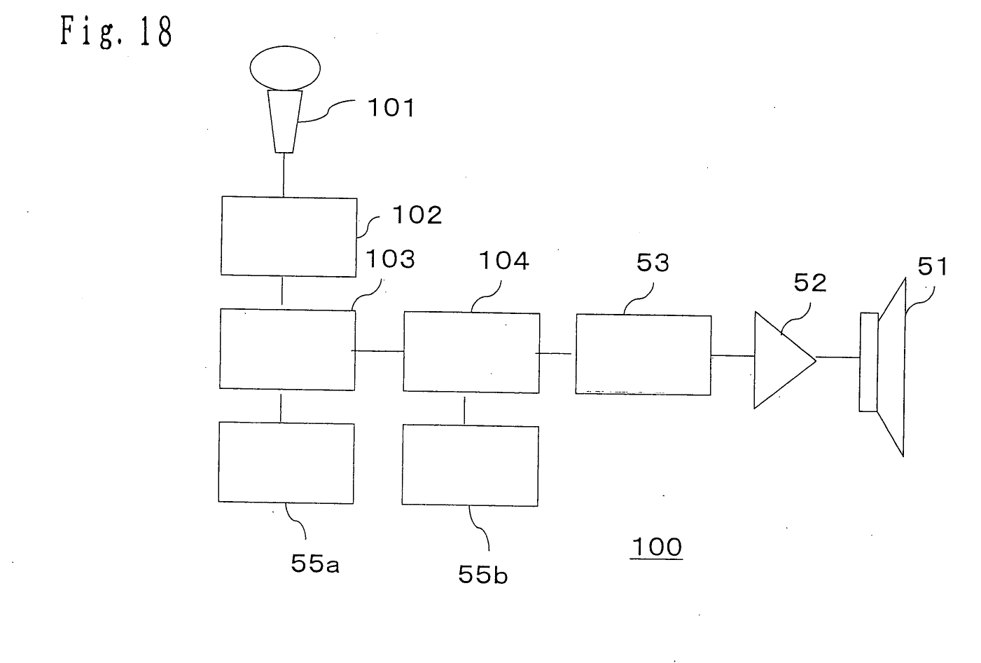

Now, FIG. 18 shows a constitution example of an alerting device that can be incorporated in the foregoing apparatus.

In this drawing, an identical or corresponding element to that of FIG. 9 is denoted by an identical numeral, and detailed description thereof will be omitted. Also, a microphone 101 is a means of acquiring an external sound; an A/D converter 102 is a means of converting the external sound signal, which is analog data acquired by the microphone 101, into digital data; an external sound identifying means 103 is a means of referring to the data stored in a memory unit 55a to identify a type of the external sound based on the digital data; an alerting tone retrieving means 104 is a means of acquiring from a memory unit 55b an alerting tone data to be output, based on the identifying result of the external sound identifying means 103. Further, the memory unit 55a is a means of storing characteristics of the background noises etc., which are the external sounds, in a form of data on sound volume or frequencies, and the memory unit 55b is a means of storing the alerting tone data such as various frequencies or various sounding patterns described in the embodiments 1 through 5.

Operation of the alerting device 100 constituted as above will be described hereunder, thereby also describing an embodiment of an alerting method according to the present invention.

Upon receipt of an input of an external sound, the microphone 101 outputs the external sound to the A/D converter 102. The A/D converter 102, upon receipt of the external sound signal, converts the signal into digital data and outputs the digital data to the external sound identifying means 103. The external sound identifying means 103 searches for characteristics that are identical or similar to those of the input digital data among the characteristics of the external sound data including the background noises etc. stored in the memory unit 55a, and identifies the external sound data having the appropriate condition as the type of the external sound. The alerting tone retrieving means 104, upon receipt of the identification result from the external sound identifying means 103, retrieves the alerting tone data 55b corresponding to the external sound according to the identification result, from the memory unit 55a. The retrieved data is output to the D/A converter 53, and the alerting tone becomes ready to be emitted in a similar manner to the example according to FIG. 9.

Also, the alerting tone retrieving means 104 may be programmed to synthesize an alerting tone data corresponding to the external sound data, in case where the corresponding alerting tone data is not stored in the memory unit 55b in the operation of the alerting tone retrieving means 104. The synthesizing of such alerting tone data may be performed by a synthesizer, which is not shown in the drawings. Storing such newly synthesized data in the memory unit 55b permits a prompt reaction in case of receiving an input of the corresponding external sound data.

Incorporating the alerting device 100 constituted as above in an apparatus enables the apparatus to identify an external sound to generate and output an optimum alerting tone in accordance with the identified external sound, even when the external circumstances have changed.

Also, the external sound data to be stored can be determined through just one measurement, however it is more preferable to work out an average value after accumulating samples over a predetermined longer period, such as a day, a week or a month. This enables selection of more accurate alerting tone data.

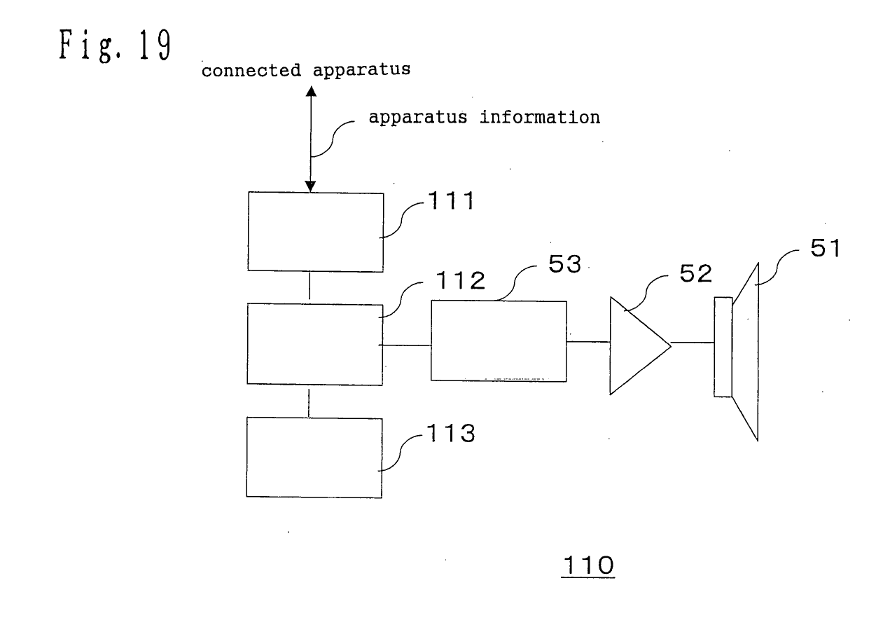

Further, another constitution example of an alerting device is shown in FIG. 19.

In this drawing, an identical or corresponding element to that of FIGS. 9 and 18 is denoted by an identical numeral, and detailed description thereof will be omitted. Also, referring to the alerting device 110, an interface means 111 is designed for example according to the IEEE1394 for connection with an apparatus collaborating with the alerting device 110, as a means of retrieving a prescribed apparatus information appropriate to the connected apparatus; an apparatus identifying means 112 is a means of retrieving from a memory unit 113 the alerting tone data corresponding to the apparatus based on the apparatus information. Also, the memory unit 113 is a means of storing the alerting tone data corresponding to the apparatus defined by the apparatus information and a look-up table for cross-reference between the apparatus information and the alerting tone data. Further, the information of the apparatus collaborating with the alerting device 110 can be constituted of information just specifying a type of the apparatus, by which an idea on an environment of use can be obtained (for example, an air-conditioner to be used in a bedroom etc., a television to be placed in a living room etc., or a refrigerator to be placed in a kitchen etc.)

Operation of the alerting device 110 constituted as above will be described hereunder, thereby also describing another embodiment of an alerting method according to the present invention.

In utilizing the alerting device 110, when the interface means 111 is connected with an apparatus, the interface means 111 retrieves apparatus information from the connected apparatus, and outputs such information to the apparatus identifying means 112. The apparatus identifying means 112, upon obtaining the apparatus information, searches in the memory unit 113 to find alerting tone data corresponding to the apparatus information referring to the look-up table, thereby retrieving the corresponding alerting tone. The alerting tone data thus retrieved is output to the D/A converter 53. Then the alerting tone becomes ready to be emitted, in a similar manner to the example according to FIG. 18.

Since an optimum frequency and sounding pattern are prescribed in advance in the alerting tone data corresponding to the apparatus based on the environment of use of the apparatus, the alerting device 110 of the aforementioned constitution can identify the connected apparatus and generate and output an optimum alerting tone suitable for the environment of use of the apparatus.

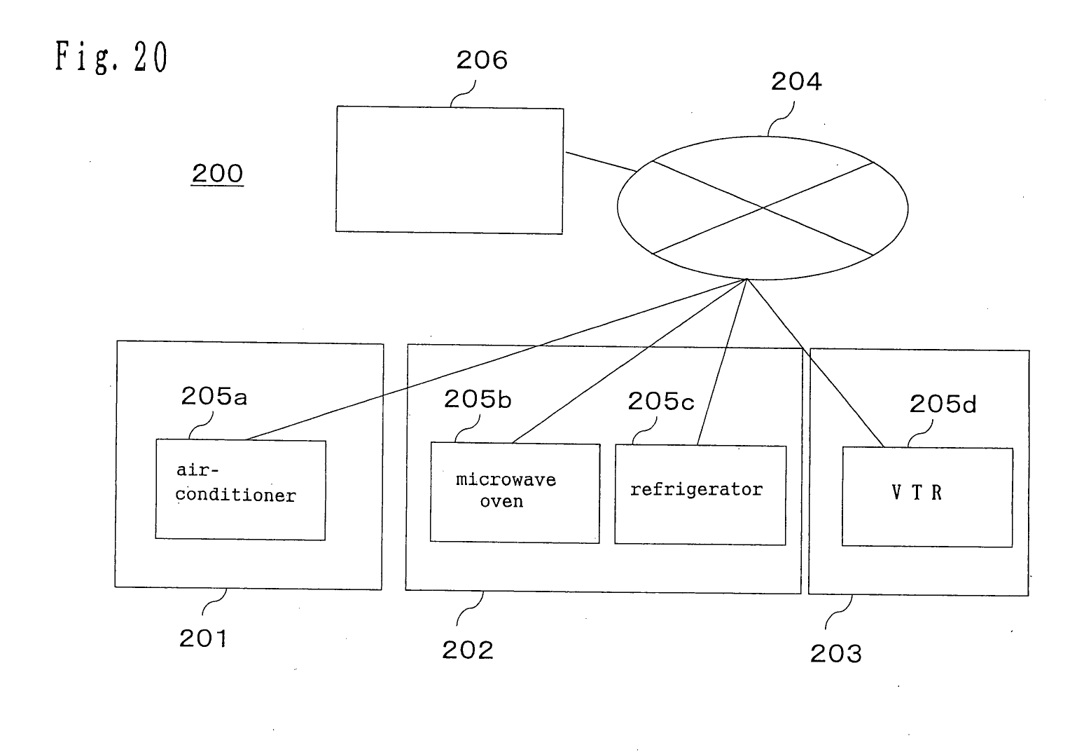

Also, the alerting device 110 may be built-in inside an apparatus as the apparatus 50 of FIG. 9, while it is also preferable to incorporate the alerting device in a network server of an in-house network. An example of constitution of such alerting system is shown in FIG. 20.

Referring to FIG. 20, the alerting system 200 is constituted of an air-conditioner 205a installed in a bedroom 201, a microwave oven 205b and a refrigerator 205c placed in a kitchen 201, a video recorder 205d placed in a living room 203 and an alerting device 206 provided in a network server, all of which are mutually connected through an in-house network 204 constituted of a lamp circuit network or Blue-Tooth etc. However, the alerting device 206 itself does not have a means of outputting an alerting tone, but is only designed to provide the alerting tone data to the apparatus including the air-conditioner 205a through the video recorder 205d. Also, it is preferable that the air-conditioner 205a through the video recorder 205d respectively have a means of outputting the provided alerting tone data as an actual alerting tone.

In such alerting system 200, the alerting device 100 collects information of the respective apparatus from the air-conditioner 205a to the video recorder 205d, and an optimum alerting tone can be selected and output according to the environment of use of the apparatus (from the bedroom 201 to the living room 203), based on the information on those apparatus.

Further, in the foregoing embodiment the alerting system 200 has in its core the alerting device 206, which acquires the apparatus information from the respective apparatus and selects and provides the alerting tone data, however the system can also be constituted so as to acquire an external sound and to select and provide the optimum alerting tone data based on the external sound, as the case of the alerting device 100. In this case, it is preferable to dispose a microphone in each of the bedroom 201 to the living room 203.

Also, though in the embodiment 6 the apparatus 50 and the alerting devices 100, 110 and 206 were designed to output the alerting tones having the frequency and sounding pattern according to the embodiments 1 through 5, the apparatus and the alerting device can also be constituted so as to select and output an alerting tone of another frequency and sounding pattern.

Further, in the above description, the memory 55 and the sound source generating unit 54 correspond to the alerting device according to the present invention. Also, the alerting devices 100, 110 and 206 correspond to the alerting device of the present invention. Also, the interface means 111 corresponds to the apparatus connecting means of the invention; the apparatus identifying means 112 and the memory unit 113 respectively correspond to the apparatus identifying means and alerting tone selecting means of the present invention; the microphone 101 corresponds to the external sound acquiring means of the present invention; the memory unit 55a and the external sound identifying means 103 correspond to the external sound identifying means of the present invention; and the memory unit 55b and the alerting tone retrieving means 104 correspond to the alerting tone selecting means of the present invention. Furthermore the air-conditioner 205a through the video recorder 205d correspond to the apparatus of the present invention. However, the apparatus according to the present invention can be arbitrarily selected, as long as the apparatus is designed to utilize an alerting tone.

Further, the alerting tone according to the present invention includes (a) response to an operation of an apparatus, (b) a tone spontaneously emitted by an apparatus, (c) a calling tone for identifying its function according to a large classification, and by the medium classification the (a) includes (a-1) a normal operation (tone for acceptance of a command, for starting, for suspending a function, for announcing a basic point, for resetting, for mode switching, for announcing completion of setting, etc.) (a-2) an abnormal operation (tone for an invalid command, for an imperfect setting, etc.), and (a-3) operation under an unmatched condition (alarm for a person responsible, alarm for insufficient environmental conditions, etc.); the (b) includes (b-1) tone in a normal state (announcing a finish, completion, completion of preparation, advance of a process, a preliminary advice, etc.), (b-2) tone of an unmatched condition (announcing an abnormal stop, abnormal preparation, erroneous operation, abnormal process, preliminary advice of an abnormality, etc.), and (b-3) tone in an abnormal state (announcing a trouble or malfunction of the apparatus); and the (c) includes tones in a normal state (calling for attention of the user).

Still further, in the above respective embodiments, the alerting tone is described as being solely constituted of a frequency specified therein, however the alerting tone of the present invention is not limited to such alerting tones but can also be a tone having a predominant frequency, i.e. a frequency predominantly contained in an alerting tone, substantially in a range lower than 3 kHz but not lower than 1.5 kHz.

Still further, in the above respective embodiments the alerting tone is described to be an alerting tone of a single frequency (beeping tone) composed in combinations of various different sounding patterns, however the alerting tone according to the present invention may also be constituted of a plurality of sounds, all or a part of which have a mutually different frequency. The alerting tone can be output in the plurality of frequencies, in the different sounding patterns described in the foregoing embodiments. Also, the alerting tone can constitute a melody, as long as a predominant frequency substantially remains in a range lower than 3 kHz or 2 kHz but not lower than 1.5 kHz.

Still further, the program according to the present invention refers to a program for causing a computer to execute the functions of all or a part of the means (or device, element, circuit, unit, etc.) of the alerting device of the present invention, and such program can be designed to work in collaboration with the computer.

Still further, the present invention provides a medium retaining a program for causing a computer to execute all or a part of the functions of all or a part of the means of the aforementioned alerting device of the present invention, and the medium may also be a medium that can be read out by the computer, and also a medium wherein the program that has been read out executes the above functions in collaboration with the computer.

Still further, the above “a part of the means (or device, element, circuit, unit, etc.)” of the present invention, and the above “a part of the steps (or process, operation, effect, etc.)” of the present invention refer to some means or steps in the plurality of means or steps, or a part of functions or a part of operations in a single means or a single step.

Furthermore, a part of the devices (or elements, circuits, units, etc.) of the present invention refers to some devices in the plurality of devices, or a part of means (or element, circuit, unit, etc.) in a single device, or a part of functions in a single means.

Furthermore, a recorded medium that can be read out by a computer and in which the program according to the present invention is stored is also included in the present invention.

Furthermore, a utilization form of the program according to the present invention may be such that the program is recorded in a recording medium that can be read out by a computer, so as to work in collaboration with the computer.

Furthermore, a utilization form of the program according to the present invention may be such that the program is transmitted through a transmission medium and read out by a computer, so as to work in collaboration with the computer.

Furthermore, data structure according to the present invention includes a database, data format, data table, data list, data types and so forth.

Also, the recording medium includes a ROM etc., and the transmission medium includes a transmission network such as the internet, light, electric wave, acoustic wave, etc.

Also, the computer according to the present invention is not limited to genuine hardware such as a CPU, but can include firmware, an OS, or further a peripheral device.

In addition, as described above, the constitution of the present invention can be accomplished either in a form of software or in a form of hardware.

Industrial Applicability

As is apparent in view of the foregoing descriptions, according to the present invention it becomes possible to design an alerting tone of an apparatus that is easily identifiable to all people regardless of age or sex in consideration of various daily life noises generated in living circumstances.

Also, despite the fact that an extent of decline of auditory capacity in elderly people is largely different depending on persons and that besides a designer of an alerting tone him/herself is unable to actually experience how difficult it is for an elderly person to hear, the present invention makes it possible to design an alerting tone from a user's viewpoint unlike the conventional laboratory level conception, thus to create an alerting tone easy to identify for the elderly people too.

Further, a psychological effect that an alerting tone causes in a human mind can also be studied, which enables designing an alerting tone through an approach focused on which kind of alerting tone is more comfortable to the human being, thereby resulting in creation of an alerting tone that is comfortable to hear for the human being.

1. An alerting device that outputs an alerting tone having a predominant frequency substantially in a range lower than about 3.0 kHz but not lower than about 1.5 kHz.

2. The alerting device as set forth in claim 1, wherein the predominant frequency of said alerting tone is substantially lower than 2.0 kHz.

3. The alerting device as set forth in claim 1 or 2, wherein said alerting tone consists of a single frequency.

4. The alerting device as set forth in claim 1 or 2, wherein said alerting tone is constituted of a plurality of sounds, all or a part of which have a mutually different frequency.

5. The alerting device as set forth in claim 1 or 2, wherein said alerting tone is constituted of combined sounds having at least one sounding pattern.

6. The alerting device as set forth in any of claim 5, wherein a frequency and/or said sounding pattern of said alerting tone are determined based on a psychological effect.

7. The alerting device as set forth in claim 5, wherein said sounding pattern includes a unit having a combination of an ON-period during which said alerting tone is being output and an OFF-period during which said alerting tone is not being output, and said unit is repeated predetermined times.

8. The alerting device as set forth in claim 7, wherein at least one of said ON-period, said OFF-period and a frequency of said alerting tone is variable.

9. The alerting device as set forth in claim 7, wherein a number of outputting times of said alerting tone in said unit is either an even number or an odd number.

10. The alerting device as set forth in claim 7, wherein a number of said predetermined repeating times is variable.

11. An alerting device comprising:
apparatus connecting means of connecting with another apparatus;
apparatus identifying means of identifying the connected apparatus; and
alerting tone selecting means of selecting the prescribed alerting tone based on a result of the identification, for outputting the alerting tone selected by the alerting tone selecting means.

12. An alerting device comprising:
external sound acquiring means of acquiring an external sound;
external sound identifying means of identifying the external sound; and
alerting tone selecting means of selecting the prescribed alerting tone based on a result of the identification, for outputting the alerting tone selected by the alerting tone selecting means.

13. The alerting device according to claim 12, wherein the identification is performed based on distribution of volume and/or frequency of the external sound.

14. The alerting device according to claim 11 or 12, wherein the prescribed alerting tone selected by the alerting tone selecting means is emitted in different frequencies and/or sounding patterns depending on the purpose of the alerting tone.

15. An alerting system comprising:
an alerting device according to claim 11; and
at least an apparatus connected with the alerting device for collaborating with the same.

16. Alerting method utilizing an alerting device capable of outputting a prescribed alerting tone, comprising the steps of:
connecting the alerting device with another apparatus;
identifying the apparatus connected with the alerting device;
selecting the prescribed alerting tone based on a result of the identification, wherein
the alerting device outputs the alerting tone selected in the selecting step.

17. Alerting method utilizing an alerting device capable of outputting a prescribed alerting tone, comprising the steps of:
acquiring an external sound produced outside the alerting device;
identifying the external sound;
selecting the prescribed alerting tone based on a result of the identification, wherein
the alerting device outputs the alerting tone selected in the selecting step.

18. A program of causing a computer to work as the apparatus connecting means of connecting with another apparatus, the apparatus identifying means of identifying the apparatus connected with the alerting device, and the alerting tone selecting means of selecting the prescribed alerting tone based on a result of the identification, according to the alerting device according to claim 11.

19. A program of causing a computer to work as the external sound acquiring means of acquiring an external sound, the external sound identifying means of identifying the external sound, and the alerting tone selecting means of selecting the prescribed alerting tone based on a result of the identification, according to the alerting device according to claim 12.

20. A recorded medium in which the programs according to the claim 18 or 19 are stored, which can be processed by a computer.
